(19) United States
(12) Patent Application Publication
(10) Pub. No.: US 2005/0069486 A1
(43) Pub. Date: Mar. 31, 2005

(54) Method and apparatus for generating hydrogen gas

(76) Inventor: Raymond Walter Shaw, New Gisbourne Victoria (AU)

Correspondence Address: MILES & STOCKBRIDGE PC, 1751 PINNACLE DRIVE, SUITE 500, MCLEAN, VA, 22102-3833, US

(21) Appl. No.: 10/487,924

(22) PCT Filed: Aug. 30, 2002
(86) PCT No.: PCT/AU02/01188

(30) Foreign Application Priority Data
Aug. 30, 2001 (AU) PR7374

(51) Int. Cl. C01B 3/06

(52) U.S. Cl. 423/658.2; 422/198

(57) ABSTRACT

A method of generating hydrogen gas is disclosed. The method includes a first step of contacting an aqueous solution of a chemical hydride and a catalyst and producing hydrogen gas and a heated hydrogen-depleted solution. The hydrogen gas is recovered and used as required, for example in a fuel cell. The heated solution is brought into direct or indirect heat exchange relationship with a metal hydride, thereby heating the metal hydride and causing desorption of hydrogen from the metal hydride and producing hydrogen gas and cooling the heated solution and producing a cooled solution. The hydrogen gas is recovered and used as required.

The present invention relates to method and apparatus for generating hydrogen gas.

The present invention also relates to a fuel cell-based system for generating electricity.

A major disadvantage of power systems, such as fuel cells, that use hydrogen gas as a source of fuel is the difficulty in generating and/or storing sufficient volumes of hydrogen gas in a safe and cost effective manner.

By way of particular example, this is a significant factor against the use of hydrogen gas-powered fuel cells for motor vehicles.

The present invention is a method and apparatus for generating hydrogen gas in a safe and cost effective manner.

Potentially, the method and apparatus of the present invention could generate sufficiently large amounts of hydrogen gas so that hydrogen gas generation/storage is not a factor against the use of hydrogen-powered fuel cells as an alternative to petrol-powered internal combustion engines.

According to the present invention there is provided a method of generating hydrogen gas which includes the steps of:
(a) contacting an aqueous solution of a chemical hydride and a catalyst and producing hydrogen gas and a heated hydrogen-depleted solution;
(b) recovering hydrogen gas produced in step (a);
(c) bringing the heated solution produced in step (a) into direct or indirect heat exchange relationship with a metal hydride and heating the metal hydride and causing desorption of hydrogen from the metal hydride and producing hydrogen gas and cooling the heated solution and producing a cooled solution; and
(d) recovering hydrogen gas produced in step (c).

The above-described method enables hydrogen gas to be recovered from two sources of hydrogen, namely chemical hydrides and metal hydrides, in a safe and an energy-efficient manner.

Specifically, the method is based on the realisation that the heated hydrogen-depleted solution that is produced in chemical hydride reaction step (a) can have sufficient thermal energy to heat metal hydrides to a temperature at which hydrogen is desorbed from the metal hydrides at an acceptable rate.

In situations where the cooled solution produced in step (c) is alkaline, preferably the method further includes contacting the solution with a metal and producing hydrogen gas and recovering the hydrogen gas.

A suitable metal is aluminium.

Preferably the method further includes treating the cooled solution produced in step (c) to regenerate the chemical hydride.

Preferably the method includes treating the cooled solution produced in step (c) to regenerate the chemical hydride by electrolysis of the cooled solution in an electrolytic cell that contains an ionic liquid, such as dicarb, as an electrolyte.

The electrolysis may be direct electrolysis of the cooled solution in the electrolyte, with some hydrogen gas generation and with the hydrogen gas being captured by the metal hydride.

The electrolysis may be indirect electrolysis with the cooled solution and the electrolyte being in separate compartments of the electrolytic cell and being separated by a barrier that is selectively permeable to ions that can form the chemical hydride, whereby the ions migrate from the compartment containing the cooled solution into the compartment containing the ionic liquid in response to an applied potential. The chemical hydride or a precursor of the chemical hydride may form as a gas or as an insoluble compound in the ionic liquid. The chemical hydride or precursor may then be extracted and recycled.

Preferably the barrier is impermeable to water and thereby prevents migration of water from the compartment containing the cooled solution into the compartment containing the ionic liquid.

Preferably step (c) includes heating the metal hydride by at least 30° C.

More preferably step (c) includes heating the metal hydride by at least 40° C.

It is preferred particularly that step (c) includes heating the metal hydride by at least 50° C.

The chemical hydride may be any suitable chemical hydride.

Suitable chemical hydrides include metal containing compounds such as lithium hydride, lithium aluminium hydride, and sodium borohydride and organic hydrides such as dimethyl borane.

Sodium borohydride is a preferred chemical hydride.

Sodium borohydride is relatively stable but can produce large amounts of hydrogen gas under suitable reaction conditions.

Specifically, sodium borohydride (NaBH₄) can react with water in the presence of a suitable catalyst (such as ruthenium) and evolve considerable amounts of hydrogen gas in accordance with the following exothermic reaction:
NaBH₄+4H₂O→4H₂+NaOH+H₃BO₃

Sodium borohydride will not spontaneously react in water to evolve hydrogen gas and the catalyst is required to initiate the reaction.

As noted above, the reaction is exothermic. Consequently, the hydrogen-depleted solution resulting from the reaction is heated, typically by 50° C.

Sodium borate is one source of sodium borohydride.

The aqueous solution of the chemical hydride supplied to step (a) may be in the form of a slurry that includes a suspension of chemical hydride particles in water that contains chemical hydride in solution.

The metal hydride may be any suitable metal hydride.

Suitable metal hydrides include iron titanium hydride and lanthanum nickel hydride.

Iron titanium hydride is a preferred metal hydride.

The rate of desorption of hydrogen gas from metal hydrides is temperature dependent.

In the case of iron titanium hydride, significant amounts of hydrogen gas can be evolved by heating the hydride by 30° C.

According to the present invention there is also provided a hydrogen gas generator that includes:
(a) a chemical hydride reactor for allowing contact between an aqueous solution of a chemical hydride and a catalyst and producing hydrogen gas and a heated hydrogen-depleted solution;
(b) a metal hydride reactor for generating hydrogen gas by heating metal hydride by direct or indirect heat exchange with heated hydrogen-depleted solution from the chemical hydride reactor and causing desorption of hydrogen from the metal hydride and generating hydrogen gas and producing a cooled solution; and
(c) a means for transferring heated solution from the chemical hydride reactor to the metal hydride reactor.

According to the present invention there is also provided a system for generating electricity that includes a fuel cell and the above-described hydrogen gas generator.

According to the present invention there is also provided an electric-powered motor vehicle which includes the above-described system for generating electricity and a means for controlling the relative amounts of hydrogen gas generated by the chemical hydride reactor and the metal hydride reactor of the system.

The present invention is described further by way of example with reference to the accompanying flow sheet of a preferred embodiment of the present invention.

The preferred embodiment is described in the context of a motor vehicle that is powered by electricity generated by a fuel cell that requires hydrogen as a feed material.

The present invention is not limited to this end-use application and extends to any other applications that require hydrogen.

With reference to the flow sheet, an aqueous slurry of a chemical hydride, namely sodium borohydride, is supplied from a tank to a first reactor and comes into contact with a catalyst, typically ruthenium, in the reactor.

The contact between the sodium borohydride slurry and the catalyst results in the evolution of considerable amounts of hydrogen gas in accordance with the following exothermic reaction:
NaBH₄+4H₂O→4H₂+NaOH+H₃BO₃

The hydrogen gas is discharged from the first reactor and is supplied to a fuel cell to generate electricity.

In view of the exothermic reaction in the first reactor, the slurry is heated, typically by 50° C., in the reactor.

The hydrogen-depleted slurry discharged from the first reactor is transferred to a heat exchanger.

In the heat exchanger the hydrogen-depleted slurry is brought into indirect heat exchange with a metal hydride, namely iron titanium hydride, in a second reactor, with the result that the iron titanium hydride is heated approximately 50° C.

Heating the iron titanium hydride causes desorption of hydrogen from the iron titanium hydride and produces hydrogen gas.

The hydrogen gas so-formed is discharged from the second reactor and is supplied to the fuel cell to generate electricity.

The indirect heat exchange between the hydrogen-depleted slurry from the first reactor and the iron titanium hydride cools the slurry by 20-30° C.

The cooled hydrogen-depleted slurry is transferred to a third reactor and is brought into contact with aluminium. The slurry is alkaline and, consequently, reacts with aluminium and generates hydrogen gas and heat. The hydrogen gas is discharged from the third reactor and is supplied to the fuel cell to generate electricity. The heat is also supplied to the fuel cell and contributes to the thermal requirements of the fuel cell.

The cooled and now neutralised hydrogen-depleted slurry, which contains boron containing liquid, is transferred to a fourth reactor in which sodium borohydride is regenerated.

Regeneration may take place in situ but more typically will occur through removal of the boron containing liquid and transfer to a separate processing facility.

The regeneration may occur through the conventional processing route for sodium borohydride with conversion of the boron component into boric acid which then becomes feedstock for producing sodium borohydride for the process. The conventional processing route involves reacting boric acid with methanol to produce tri-methyl borate which is then reacted with sodium hydride at elevated temperatures. This yields sodium borohydride and sodium hydroxide (caustic soda) together with methyl products which can be re-used in the process as methanol, plus some impurities and oils which are removed in a purification process.

More preferably, in a second regeneration option, regeneration will be through novel electrochemical processing involving the use of the new generation of electrolytes termed ionic liquids. These liquids have the capability to allow electrolysis at relatively low temperatures at voltages sufficient to drive the formation of strongly reducing compounds such as sodium borohydride without dissociating themselves as would be the case in an aqueous electrolyte.

The exact configuration will depend upon the specific ionic liquid. In some cases the configuration will include direct electrolysis of the slurry, with some hydrogen gas generation and with the hydrogen gas being captured by the metal hydride system. In other configurations will include the removal of the water, possible separation of the aluminium if present, and electrolysis of the sodium boron containing solution.

The direct electrolysis route has the attraction of in situ regeneration of the sodium borohydride during periods when the system is not required to produce hydrogen for feed to the fuel cell.

The ex situ use of ionic liquids may involve producing intermediate compounds which are subsequently converted to a suitable hydride. In one configuration the electrolysis would be carried out in an electrolytic cell which contains a membrane or diaphragm to separate the electrode compartments, one of which contains an ionic liquid electrolyte. The hydride species and/or a suitable intermediate is generated from the ionic liquid containing compartment and separated out for use. This arrangement enables the hydride produced to avoid contact with water from the solution being regenerated or originating from the electrolysis reaction and therefore minimises the chances of back reaction and loss of efficiency in the cell. This can then enable less stable intermediates which are highly reactive with water, such as diborane gas, to be generated during the electrolysis and captured for subsequent reaction.

A third regeneration option is to direct high temperature formation of the sodim borohydride from the boron-sodium liquor through high temperature reaction in the presence of a hydrogen source, preferably natural gas (=methane), and a strong reductant to drive the reaction. The reductant will preferably be one or a combination of relatively inexpensive metals such as aluminium, sodium magnesium, silicon or titanium and carbon possibly supplemented by some hydrogen gas.

In the context of an electric-powered motor vehicle in which electricity is generated by a fuel cell, the use of a chemical hydride (such as sodium borohydride) and a metal hydride (such as iron titanium hydride) as sources of hydrogen gas, and the linking of the chemical hydride and metal hydride reactions by using the heat generated by the chemical hydride reaction to cause the metal hydride reaction, is a considerable advantage.

The above-described system alleviates the volume efficiency and weight efficiency problems generally associated with the use of hydrogen in motor vehicles. Specifically, the above-described system takes advantage of the volume efficiency of metal hydrides and the weight efficiency of chemical hydrides. Moreover, the combination of metal hydrides and chemical hydrides compensates for the poor weight efficiency of metal hydrides and the poor volume efficiency of chemical hydrides.

In the context of motor vehicles, both chemical and metal hydrides are renewable sources of energy. It is envisaged that motor vehicles be designed so that suitable “tanks” of sodium borohydride slurry (or other suitable chemical hydride slurry) and iron titanium hydride (or other suitable metal hydride) are replaced as required and the used sodium borohydride and iron titanium hydride are regenerated for subsequent re-use.

In the context of a motor vehicle, the system further includes a control means for regulating the supply of hydrogen generated in the first reactor by catalytic reaction of sodium borohydride slurry and in the second reactor by desorption from iron titanium hydride.

Specifically, it is envisaged that the sodium borohydride be used to generate hydrogen on ignition and during acceleration and that the iron titanium hydride be used to generate hydrogen during the other phases of operation of a motor vehicle.

Many modifications may be made to the preferred embodiment of the present invention described above without departing from the spirit and scope of the invention.

By way of example, whilst the preferred embodiment is described in the context of sodium borohydride and iron titanium hydride, the present invention is not so limited and extends to any suitable chemical hydrides and metal hydrides.

By way of further example, whilst the preferred embodiment describes the use of ruthenium as the catalyst, the present invention is not so limited and extends to any suitable catalyst for chemical hydrides.

1. A method of generating hydrogen gas which includes the steps of:
(a) contacting an aqueous solution of a chemical hydride and a catalyst and producing hydrogen gas and a heated hydrogen-depleted solution;
(b) recovering hydrogen gas produced in step (a);
(c) bringing the heated solution produced in step (a) into direct or indirect heat exchange relationship with a metal hydride and heating the metal hydride and causing desorption of hydrogen from the metal hydride and producing hydrogen gas and cooling the heated solution and producing a cooled solution; and
(d) recovering hydrogen gas produced in step (c).

2. The method defined in claim 1 further including contacting the cooled solution produced in step (c) with a metal and producing hydrogen gas and recovering the hydrogen gas in situations in which the cooled solution is alkaline.

3. The method defined in claim 2 wherein the metal is aluminium.

4. The method defined in claim 1 further including treating the cooled solution produced in step (c) to regenerate the chemical hydride.

5. The method defined in claim 1 further including treating the cooled solution produced in step (c) to regenerate the chemical hydride by electrolysis of the cooled solution in an electrolytic cell that contains an ionic liquid as an electrolyte.

6. The method defined in claim 5 wherein electrolysis is indirect electrolysis with the cooled solution and the electrolyte being in separate compartments of the electrolytic cell and being separated by a barrier that is selectively permeable to ions that can form the chemical hydride, whereby the ions migrate from the compartment containing the cooled solution into the compartment containing the ionic liquid in response to an applied potential.

7. The method defined in claim 6 wherein the chemical hydride or a precursor of the chemical hydride form as a gas or as an insoluble compound in the ionic liquid.

8. The method defined in claim 7 further includes extracting the chemical hydride or precursor from the ionic liquid.

9. The method defined in claim 1 wherein step (c) includes heating the metal hydride by at least 30° C.

10. The method defined in claim 9 wherein step (c) includes heating the metal hydride by at least 40° C.

11. The method defined in claim 10 wherein step (c) includes heating the metal hydride by at least 50° C.

12. The method defined in claim 1 wherein the chemical hydride includes any one or more of lithium hydride, lithium aluminium hydride, sodium borohydride, and dimethyl borane.

13. The method defined in claim 1 wherein the chemical hydride is sodium borohydride.

14. The method defined in claim 1 wherein the aqueous solution of the chemical hydride supplied to step (a) is in the form of a slurry that includes a suspension of chemical hydride particles in water that contains the chemical hydride in solution.

15. The method defined in claim 1 wherein the metal hydride includes any one or more of iron titanium hydride and lanthanum nickel hydride.

16. A hydrogen gas generator comprising:
(a) a chemical hydride reactor for allowing contact between an aqueous solution of a chemical hydride and a catalyst and producing hydrogen gas and a heated hydrogen-depleted solution;
(b) a metal hydride reactor for generating hydrogen gas by heating metal hydride by direct or indirect heat exchange with heated hydrogen-depleted solution from the chemical hydride reactor and causing desorption of hydrogen from the metal hydride and generating hydrogen gas and producing a cooled solution; and
(c) a means for transferring heated solution from the chemical hydride reactor to the metal hydride reactor.

17. The generator defined in claim 16 further comprising means for regenerating the chemical hydride from the cooled solution produced in the metal hydride reactor.

18. The generator defined in claim 17 wherein the means for regenerating the chemical hydride includes an electrolytic cell.

19. The generator defined in claim 18 wherein the electrolytic cell includes two compartments separated by a barrier that is selectively permeable to ions that can form the chemical hydride.

20. A system for generating electricity comprising a fuel cell and a hydrogen gas generator comprising:
(a) a chemical hydride reactor for allowing contact between an aqueous solution of a chemical hydride and a catalyst and producing hydrogen gas and a heated hydrogen-depleted solution;
(b) a metal hydride reactor for generating hydrogen gas by heating metal hydride by direct or indirect heat exchange with heated hydrogen-depleted solution from the chemical hydride reactor and causing desorption of hydrogen from the metal hydride and generating hydrogen gas and producing a cooled solution; and
(c) a means for transferring heated solution from the chemical hydride reactor to the metal hydride reactor.

21. An electric-powered motor vehicle which comprising a system for generating electricity, said electricity generating system comprising a fuel cell and a hydrogen gas generator, wherein said hydrogen gas generator comprises:
(a) a chemical hydride reactor for allowing contact between an aqueous solution of a chemical hydride and a catalyst and producing hydrogen gas and a heated hydrogen-depleted solution;
(b) a metal hydride reactor for generating hydrogen gas by heating metal hydride by direct or indirect heat exchange with heated hydrogen-depleted solution from the chemical hydride reactor and causing desorption of hydrogen from the metal hydride and generating hydrogen gas and producing a cooled solution; and
(c) a means for transferring heated solution from the chemical hydride reactor to the metal hydride reactor
and a means for controlling the relative amounts of hydrogen gas generated by the chemical hydride reactor and the metal hydride reactor of said system.
